(19) United States
(12) Patent Application Publication
(10) Pub. No.: US 2010/0285286 A1
(43) Pub. Date: Nov. 11, 2010

(54) ELASTIC LAMINATES

(75) Inventor: Jeffrey Alan Middlesworth, Wauconda, IL (US)

Correspondence Address: MCANDREWS HELD & MALLOY, LTD, 500 WEST MADISON STREET, SUITE 3400, CHICAGO, IL, 60661, US

(73) Assignee: PLIANT CORPORATION, Schaumburg, IL (US)

(21) Appl. No.: 12/095,804

(22) PCT Filed: Sep. 13, 2006
(86) PCT No.: PCT/US2006/035723

§ 371 Date: Jul. 16, 2010

Related U.S. Application Data
(60) Provisional application No. 60/739,697, filed on Nov. 22, 2005.

(51) Int. Cl. B32B 27/12; B32B 7/12; B32B 7/04; B32B 38/00

(52) U.S. Cl. 428/196; 442/394; 156/163

(57) ABSTRACT

The presently described technology provides one or more types of low cost elastic laminates with improved elasticity via stretching of an elastic layer, a non-woven layer, or the overall laminate that achieves reduced processing time and cost, can be utilized in a variety of end-user applications, and further provides self-warning capability to end-users of potential film and/or laminate overstretch. The described elastic laminates have at least one elastic layer and at least two non-woven layers, in which the elastic layers has at least one inelastic region formed via heating, incremental stretching, severing, or bonding. Additionally, heat shrink laminates having improved elasticity and compatibility with various laminate components are also described. Processes and systems for the manufacture of the described elastic laminates are also provided.

### BACKGROUND OF THE INVENTION

The presently described technology relates generally to elastic laminates. More specifically, the presently described technology relates to elastic laminates with stretched non-woven layers and heat shrink elastic layers. The presently described technology also relates to stretched elastic laminates and elastic laminates with inelastic regions.

Disposable absorbent articles (e.g., disposable diapers for children or adults) often include elastic features designed to provide enhanced and sustainable comfort and fit to the wearer by conformably fitting to the wearer over time. Examples of such elastic features may include, for example, elastic waist features, elastic leg cuffs, elastic side tabs, or elastic side panels so that the absorbent article can expand and contract to conform to the wearer in varying directions. Additionally, such elastic features are often required to be breathable to provide a desired level of comfort to the wearer's skin.

Further, the elastic features of disposable absorbent articles may be made of elastic laminates containing, for example, elastic films (including breathable films) or elastic scrims, further laminated to non-woven fabrics providing desired surface properties and aesthetics to the elastic laminate. The elastic properties of such elastic laminates are often obtained by activating the elastic properties within the elastic laminate, which can be latent before activation. That is, the elastic laminate which is non-elastic by itself before the activation becomes elastic after the activation, as if it were itself elastic initially.

One of the previously utilized activation techniques involves mechanical stretching of the elastic laminate. Such mechanical stretching is believed to provide permanent elongation of the non-woven substrate(s) within the elastic laminate to enable the elastic member(s) of the same elastic laminate (e.g., elastic film or elastic scrim) to stretch under a tension force applied thereto. When the elastic member is allowed to contract, the permanently elongated non-woven fabric wrinkles or shins to contract in at least one dimension along with the elastic member. In doing so, the mechanically stretched compound material becomes an elastic or an elasticized material.

The elastic member of an elastic laminate may also be stretched. The elastic member may be stretched in the machine direction, for example. More particularly, the elastic member may be stretched in the machine direction by multiple pairs of rollers, each pair of rollers operating at different speeds. For illustrative purposes only, Jacobs (U.S. Pat. No. 5,814,178) discloses stretching a continuous elastic film in the machine direction with multiple pairs of rollers, each pair of rollers operating at different speeds.

The elastic member may also be stretched in the cross direction. More particularly, the elastic member may be stretched in the cross direction by a tenter frame. For example, Reiter (U.S. Pat. No. 4,563,185) discloses stretching a continuous elastic film in the cross direction with a tenter frame.

Conventional means of stretching, like those noted above and in particular tenter frames, are problematic for several reasons. First, tenter frames are expensive. Second, tenter frames require a significant amount of space, even for a relatively small stretch distance. Third, tenter frames do not evenly stretch the elastic member and may, even cause the elastic member to break. Lastly, tenter frames produce a significant amount of film and/or laminate waste.

The elastic member may be stretched in the cross direction by a pair of canted wheels. For example, Herrin (U.S. Pat. No. 5,308,345) discloses stretching elastic strips in the cross direction with a pair of solid canted wheels. Ruscher et al. (U.S. Pat. No. 5,560,793) discloses stretching a continuous elastic film in the cross direction with a pair of hollow cylindrical rims.

Alternatively, the elastic member may be incrementally stretched with intermeshing gears. For illustrative purposes only, Wu (U.S. Pat. No. 5,422,172) and Weber et al. (U.S. Pat. No. 5,167,897) discloses stretching an elastic film with intermeshing gears.

The elastic member may also be bi-axially or bi-directionally stretched. More particularly, the elastic member may be stretched in both the machine direction and the cross direction. For example, Wick (U.S. Pat. No. 5,182,069) discloses stretching a continuous elastic film in both the machine direction and the cross direction using a tenter frame.

Conventional elastic laminates, like those described above, are also problematic for several reasons. First, conventional elastic laminates are easily overstretched, and thus permanently damaged, without the user's knowledge. Such outcomes lend to increased processing cost, increased processing inefficiencies, use of expensive and complicated equipment, and excessive waste.

Second, conventional elastic laminates are typically difficult to stretch for the first or initial time. More particularly, the first or initial stretch of an elastic laminate typically requires significantly more force than the second or subsequent stretch. The additional force may be a result of the Mullin's effect. Additionally, the first or initial stretch does not return to the same position as the second or subsequent stretches. Consequently, the tactile perception of an end user stretching the elastic laminate for the first or initial time may be inferior to that of an end user stretching the elastic laminate the second or subsequent times. In other words, an end user may notice poor elastic performance during the first or initial use of the laminate as compared to the second or subsequent uses.

Another of the previously known activation techniques for an elastic laminate involves the application of heat. More particularly, if the elastic member (e.g., elastic film or elastic scrim) includes a heat shrink material, then the application of heat will cause the elastic member to shrink. Consequently, the contraction of the elastic member will cause the non-woven fabric to wrinkle or shirr. For example, Hodgson, Jr. et al. (U.S. Pat. No. 4,714,735 and U.S. Pat. No. 4,820,590) discloses a heat shrink elastic film. Additionally, for example, Brandon et al. (U.S. Pat. No. 5,916,203) discloses a heat shrink elastic scrim.

Heat shrink materials are typically more affordable than other elastic materials and require no stretching to obtain their elastic properties. However, heat shrink materials are typically not as elastic as other elastic materials. Thus, heat shrink materials have limited elastic applications due to their inherent property limitations. Additionally, the activation temperature is a fixed property of a heat shrink material. Consequently, other materials in the elastic laminate, such as glue, for example, must be compatible with the activation temperature of the heat shrink material. As a result, the incorporation of such materials into elastic laminates becomes difficult and can lead to increased cost.

Elastic laminates with inelastic regions are also desirable for improved attachment to other members of a disposable absorbent article, such as an infant diaper. Inelastic regions may be created by reinforcement. Cree et al. (U.S. Pat. No. 6,255,236) discloses, for example, reinforcing the elastic laminate to create inelastic regions. The inelastic regions may also be created by coextrusion. Swenson et al. (U.S. Pat. No. 5,462,708) discloses, for example, coextrusion of an elastic laminate with inelastic regions. Further, as previous discussed, the inelastic regions may be created by preferential activation of a heat shrink elastic laminate. Hanschen et al. (U.S. Pat. No. 5,344,691 and U.S. Pat. No. 5,468,428) discloses, for example, preferential activation of a heat shrink elastic laminate to create the inelastic regions.

However, creating inelastic regions in elastic laminates is typically expensive and inefficient. For example, creating inelastic regions by reinforcement, like those disclosed in Cree, typically requires the inclusion of additional material for reinforcement, thereby adding to the cost of the elastic laminate. Additionally, creating inelastic regions by coextrusion or heat shrink activation, as disclosed in Swenson and Hanschen, respectively, typically requires a complicated and time-consuming set-up procedure and the use of expensive machinery. Further, systems for manufacturing such elastic regions are not interchangeable with or easily converted to systems for manufacturing other types of elastic laminates. Thus, their cost cannot be offset over a variety of applications.

Thus, there is a need for a low cost elastic laminate. More particularly, there is a need for a low cost elastic laminate with improved elasticity that is easy to use and self-warns a user of a potential overstretch. There is also a need for a low cost elastic laminate with inelastic regions. Additionally, there is a need for a heat shrink elastic laminate having improved elasticity and compatibility.

### SUMMARY OF THE INVENTION

The presently described technology provides elastic laminates and systems and methods for manufacturing elastic laminates.

In one aspect, the presently described technology provides an elastic laminate with a stretched non-woven layer. In one embodiment of the presently described technology, the elastic laminate includes an elastic layer and a non-woven layer. The non-woven layer may be stretched and subsequently attached to the elastic layer.

The presently described technology also provides a method for manufacturing an elastic laminate with a stretched non-woven layer. In one embodiment of the presently described technology, the method may include stretching a non-woven layer and attaching the stretched non-woven layer to an elastic layer.

The presently described technology also provides a system for manufacturing an elastic laminate. In one embodiment of the presently described technology, the system may include a stretching unit for stretching a non-woven layer.

In another aspect, the presently described technology provides a heat shrink elastic laminate. In one embodiment of the presently described technology, the elastic laminate may include a heat shrink elastic layer and a non-woven layer. The heat shrink elastic layer may be stretched and subsequently attached to the non-woven layer.

The presently described technology also provides a method for manufacturing a heat shrink elastic laminate. In one embodiment of the presently described technology, the method may include stretching a heat shrink elastic layer, attaching the stretched heat shrink elastic layer to a non-woven layer, and applying heat to contract the heat shrink elastic layer.

The presently described technology also provides a system for manufacturing a heat shrink elastic laminate. In one embodiment of the presently described technology, the system may include a stretching unit for stretching a heat shrink elastic layer and a heating unit for activating the heat shrink elastic layer.

In another aspect, the presently described technology also provides a stretched elastic laminate. In one embodiment of the presently described technology, the elastic laminate may include an elastic layer and a non-woven layer. The elastic layer may be stretched and subsequently attached to the non-woven layer to form an elastic laminate. The elastic laminate may then be stretched.

The presently described technology also provides a method for manufacturing a stretched elastic laminate. In one embodiment of the presently described technology, the method may include stretching an elastic layer, attaching the stretched elastic layer to a non-woven layer to form an elastic laminate, and stretching the elastic laminate.

The presently described technology also provides a system for manufacturing a stretched elastic laminate. In one embodiment of the presently described technology, the system may include a stretching unit for stretching an elastic laminate.

In another aspect, the presently described technology provides an elastic laminate with an inelastic region. The elastic laminate includes an elastic layer and a non-woven layer. In one embodiment of the presently described technology, the elastic layer may be stretched and attached to the non-woven layer. A portion of the stretched elastic layer may be heated to form an inelastic region.

In another embodiment of the presently described technology, a portion of the elastic layer may be stretched and then the entire elastic layer may be stretched to form an inelastic region. The stretched elastic layer is attached to the non-woven layer.

In another embodiment of the presently described technology, a portion of the elastic layer may be rigidly attached to the non-woven layer to form an inelastic region.

In another embodiment of the presently described technology, a first portion of the elastic layer may be attached to the non-woven layer. A second portion of the elastic layer may be severed from the first portion of the elastic layer to form an inelastic region.

The presently described technology also provides a method for manufacturing an elastic laminate with an inelastic region. In one embodiment of the presently described technology, the method may include stretching an elastic layer, attaching the stretched elastic layer to a non-woven layer, and heating a portion of the stretched elastic layer to form an inelastic region.

In another embodiment of the presently described technology, the method may include stretching a portion of an elastic layer, stretching the entire elastic layer to form an inelastic region, and attaching the stretched elastic layer to a non-woven layer.

In another embodiment of the presently described technology, the method may include stretching an elastic layer and rigidly attaching a portion of the stretched elastic layer to a non-woven layer to form an inelastic region.

In another embodiment of the presently described technology, the method may include attaching a first portion of the elastic layer to a non-woven layer, and severing a second portion of the elastic layer from the first portion of the elastic layer to form an inelastic region.

The presently described technology also provides a system for manufacturing an elastic laminate with an inelastic region. In one embodiment of the presently described technology, the system may include a stretching unit for stretching an elastic layer, an attaching unit for attaching the stretched elastic layer to a non-woven layer, and a heating unit for applying heat to a portion of the stretched elastic layer to form an inelastic region.

In another embodiment of the presently described technology, the system may include a first stretching unit for stretching a portion of an elastic layer, a second stretching unit for stretching the entire elastic layer to form an inelastic region, and an attaching unit for attaching the stretched elastic layer to a non-woven layer.

In another embodiment of the presently described technology, the system may include an attaching unit for rigidly attaching a portion of an elastic layer to a non-woven layer to form an inelastic region.

In another embodiment of the presently described technology, the system may include an attaching unit for attaching a first portion of the elastic layer to a non-woven layer and a severing unit for severing a second portion of the elastic layer from the first portion of the elastic layer to form an inelastic region.

### BRIEF DESCRIPTION OF THE DRAWINGS

FIG. 1 illustrates a cross sectional view of an elastic laminate, according to at least one embodiment of the presently described technology.

FIG. 2 illustrates a method of manufacturing an elastic laminate, according to at least one embodiment of the presently described technology.

FIG. 3 illustrates a cross-sectional view of an elastic laminate with an inelastic region formed by incrementally stretching a portion of an elastic layer, according to at least one embodiment of the presently described technology.

FIG. 4 illustrates a cross-sectional view of an elastic laminate with an inelastic region formed by heating a portion of an elastic layer, according to at least one embodiment of the presently described technology.

FIG. 5 illustrates a cross-sectional view of an elastic laminate with an inelastic region formed by ultrasonic bonding a portion of an elastic layer, according to at least one embodiment of the presently described technology.

FIG. 6 illustrates a cross-sectional view of an elastic laminate with an inelastic region formed by severing a portion of an elastic layer, according to at least one embodiment of the presently described technology.

FIG. 7 includes a system for manufacturing an elastic laminate, according to at least one embodiment of the presently described technology.

The foregoing summary, as well as the following detailed description of certain embodiments of the presently described technology, will be better understood when read in conjunction with the appended drawings. For the purpose of illustrating the presently described technology, certain embodiments are shown in the drawings. It should be understood, however, that the presently described technology is not limited to the arrangements and instrumentality shown in the attached drawings.

### DETAILED DESCRIPTION OF THE PREFERRED EMBODIMENTS

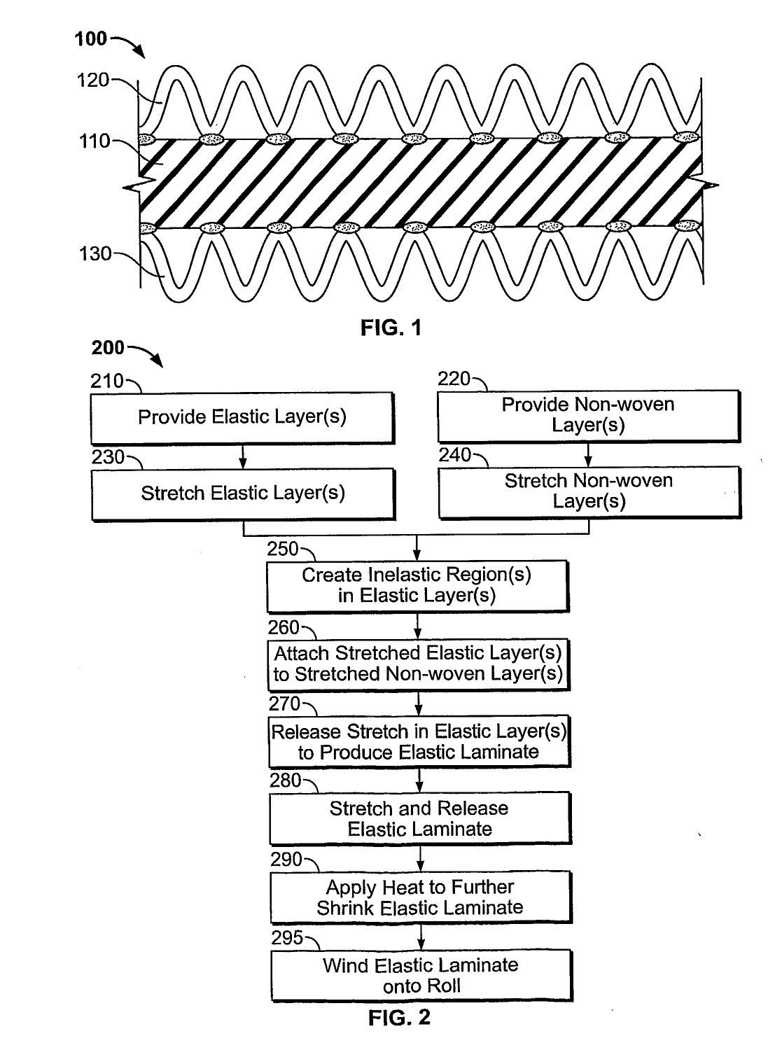

FIG. 1 illustrates a cross sectional view of an elastic laminate 100, according to at least one embodiment of the presently described technology. The elastic laminate 100 includes at least one elastic layer 110 and at least two non-woven layers 120, 130. Alternatively, the elastic laminate 100 may include only one non-woven layer. Thus, it should be understood by those skilled in the art that the presently described technology may be configured in many ways, for example, in three, four, five, or any number of layers, as desired.

The elastic layer 110 includes an elastic film. For example, Middlesworth et al. (U.S. Pat. No. 6,537,930), herein incorporated by reference, and Morman et al. (U.S. Pat. No. 6,001,460), herein incorporated by reference, disclose several types of elastic films that may be included in the elastic layer 110. The elastic film may be continuous, such as an elastic web, or discontinuous, such as an elastic strip. The elastic film preferably includes a styrene elastomer blend having styrene-ethylene-butylene-styrene (SEBS) block copolymer(s) as a major component. In at least one embodiment of the presently described technology, the elastic film preferably includes a coextrusion of VISTAMAXX™ ethylene-propylene copolymer, available from ExxonMobile Chemical (Houston, Tex.), and polyethylene skin layers to encapsulate the entire structure.

The non-woven layers 120, 130 include at least one or more types of non-woven fabric. For example, Cree et al. (U.S. Pat. No. 6,255,236), herein incorporated by reference, discloses several types of non-woven fabrics that may be included in or as the non-woven layers 120, 130. The non-woven fabric preferably includes a homopolymer polypropylene spunbond with a basis weight of about 15 grams per square meter or less. More preferably, the non-woven fabric includes a homopolymer polypropylene spunbond with a basis weight of 10 grams per square meter or less. For example, the non-woven fabric may include Sofspan™ or Dreamex™, both available from BBA Fiberweb (London, England).

Non-woven fabrics with lower basis weights may be thinner than comparable non-woven fabrics with higher basis weights, thereby reducing the negative cost implications associated with the non-woven layers 120, 130, as described below. Additionally, non-woven fabrics with lower basis weights may bond to other laminate components (e.g., elastic films) faster than comparable non-woven fabrics with higher basis weights, thereby reducing the processing time and production cost of the resultant elastic laminate 100. However, non-woven fabrics with lower basis weights may delaminate if the fabrics are too thin (i.e., not enough non-woven fibers at most of the bond sites).

The elastic layer 110 may be located or positioned between the non-woven layers 120, 130. The elastic layer 110 may be attached or bonded to the non-woven layers 120, 130. More particularly, the elastic layer 110 may be stretched before being attached or bonded to the non-woven layers 120, 130. The non-woven layers 120, 130 may be stretched before being attached or bonded to the elastic layer 110. Additionally, the stretched elastic layer 110 may be attached or bonded to the stretched non-woven layers 120, 130.

In one embodiment of the presently described technology, the stretched elastic layer 110 and the stretched non-woven layers 120, 130 may be attached or bonded and released to create or produce the elastic laminate 100. More particularly, the elastic layer 110, which is relatively elastic, may return to approximately its pre-stretched, pre-activated dimensions when released. The elastic layer 110 preferably returns to within about 30 percent of its pre-stretched, pre-activated dimensions when released. More preferably, the elastic layer 110 returns to within about 20 percent of its pre-stretched, pre-activated dimensions when released. Still more preferably, the elastic layer 110 returns to within about 10 percent of its pre-stretched, pre-activated dimensions when released. Conversely, the non-woven layers 120, 130, which are relatively inelastic, may remain in a permanently stretched or elongated state or condition following release. Thus, the non-woven layers 120, 130 may remain operatively attached or bonded to the elastic layer 110 and may proceed to wrinkle, bunch, gather, or shirr as the elastic layer 110 returns to approximately its pre-stretched dimensions.

Stretching the non-woven layers 120, 130 prior to attachment to the elastic layer 110 may have several advantages. Stretching the non-woven layers 120, 130 is believed to reduce the amount of non-woven material required, and thus, the overall cost to produce the resultant elastic laminate 100. For example, if the width of the elastic layer 110 is stretched or elongated by 100 percent, then the widths required for the non-woven layers 120, 130 are approximately two times the width of the elastic layer 110. Conversely, for example, if the widths of non-woven layers 120, 130 are also stretched or elongated by 100 percent, then less non-woven material is required as compared to the previous example noted above. Thus, the overall cost of the resultant elastic laminate 100 may be reduced.

Additionally, stretching the non-woven layers 120, 130 is believed to partially orient the fibers of the non-woven layers 120, 130, thereby creating a force wall (i.e., an elongation at which the slope of the stress-strain curve becomes steeper). In other words, when a user stretches the elastic laminate 100 with stretched non-woven layers 120, 130, stretching may become significantly more difficult as an end user reaches the force wall, thereby warning the end user that the elastic laminate 100 is becoming overstretched and on the verge of failure. Early warning of such a deleterious outcome may significantly reduce waste associated with the manufacture of end products containing such films and laminates.

Table 1, as provided below, illustrates the concept of a force wall C. More particularly, Table 1 illustrates the expected stress-strain curve A for the elastic laminate 100 of FIG. 1 with unstretched non-woven layers 120, 130. Additionally, Table 1 illustrates the expected stress-strain curve B for elastic laminate 100 with stretched non-woven layers 120, 130. The expected stress-strain curves A, B are similar, except for the force wall C. As illustrated in Table 1, the force wall C includes an elongation D at which the stress-strain curve B becomes steeper, as compared to the stress-strain curve A.

TABLE 4
Stress-Strain Curves for Stretched and Unstretched Non-Woven Layers

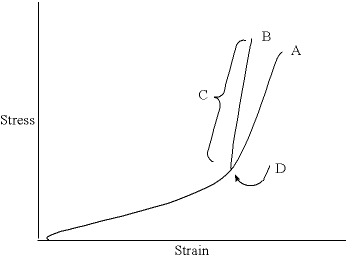

If the elastic layer 110 includes a heat shrink material in the layer's make-up, heat may be applied to the elastic laminate 100 to activate the heat shrink material in the elastic layer 110 and further shrink the elastic layer 110, thereby improving or enhancing the elasticity of the elastic laminate 100. Heat shrink materials preferably include, but are not limited to, ethylene copolymers, such as ethylene-vinyl acetate (EVA), ethylene methylacrylate (EMA), or ethylene acrylic acid (EAA). Additionally, heat shrink materials may also include very low density materials, such as metallocene catalyzed linear low density polyethylene (LLDPE). Heat shrink materials useful in the practice of at least one embodiment of the presently described technology are preferably activated at temperatures ranging from about 120 degrees Fahrenheit to about 200 degrees Fahrenheit. More particularly, heat shrink materials are preferably activated at temperatures ranging from about 120 degrees Fahrenheit to about 140 degrees Fahrenheit. The application of heat preferably contracts the heat shrink elastic layer 110 by at least about 20 percent of its inactivated dimensions, more preferably at least about 35 percent of its inactivated dimensions, and most preferably at least about 50 percent of its inactivated dimensions.

In another embodiment of the presently described technology, the elastic laminate 100 may be stretched and released. More particularly, the elastic laminate 100 is preferably stretched or elongated from about 80 percent to about 120 percent of the stretch or elongation of the elastic layer 110. For example, if the elastic layer 110 is stretched or elongated to 100 percent of its pre-stretched, pre-activated dimensions, then the elastic laminate 110 may be stretched or elongated from about 80 percent to about 120 percent of its pre-stretched dimensions. As appreciated by one of ordinary skill in the art, the elastic laminate 100 should not be stretched beyond the limit of the underlying elastic layer 110, even if the limit is within the aforementioned range.

Alternatively, if the elastic layer 110 includes a heat shrink material, the elastic laminate 100 may be stretched or elongated about 80 percent to about 120 percent of the shrink or contraction of the elastic layer 110. For example, if the heat shrink elastic layer 110 shrinks or contracts to 50 percent of its pre-contracted, pre-activated dimensions, then the elastic laminate 110 may be stretched or elongated from about 40 percent to about 60 percent of its pre-stretched dimensions.

The previously-stretched elastic layer 100 may be included as a component of an elastic article, such as a disposable infant diaper. For example, the elastic waistband in a disposable pull-up training diaper may include the previously-stretched elastic laminate 100.

Subjecting the elastic laminate 100 to a first stretch cycle before incorporating the elastic laminate 100 in an end product may have several advantages over the prior art compositions and processes. The elastic laminate 100 is believed to be easier to stretch the second and subsequent times as compared to the first or initial time. The elastic laminate 100 may also stretch more consistently between second and subsequent stretches as compared to the first or initial stretch. These advantages are illustrated in more detail below.

Table 2, as provided below, illustrates the expected stretch path of the elastic laminate 100 of FIG. 1, according to at least one embodiment of the presently described technology. The expected stretch path includes a first stretch path A, a first return path B, a second or subsequent stretch path C, and a second or subsequent return path D. The first stretch path A includes a first stretch point E. The first return path B, the second or subsequent stretch path C, and the second or subsequent return path D include a first return point, a second or subsequent stretch point, and a second or subsequent return point, collectively designated as point F on Table 2.

As shown in Table 2, the first stretch A requires more force than the second and subsequent stretches C. Consequently, a user stretching the elastic laminate 100 of FIG. 1 for the first time may experience more difficulty in comparison to stretching the elastic laminate 100 for the second and subsequent times. However, it is believed that such difficulties would not be present in the previously-stretched elastic laminate 100.

Additionally, as shown in Table 2, the first stretch point E is different from the first return point F, illustrating an inconsistency in the elasticity of the laminate 100 of FIG. 1 (i.e., when stretched for the first time, the elastic laminate 100 does not return to the same position or path in which the stretching was started or initiated). Conversely, the second or subsequent stretch paths start and end in approximately the same position (i.e., the second or subsequent stretch and return points, collectively referred to as point F). Consequently, an end user stretching the elastic laminate 100 for the first time is believed to perceive an imperfect return as compared to stretching the elastic laminate 100 for the second or subsequent time. However, it is believed that such imperfections would not be present in the previously-stretched elastic laminate 100.

TABLE 2
Stretch Paths for First and Subsequent Stretches of Elastic Laminate

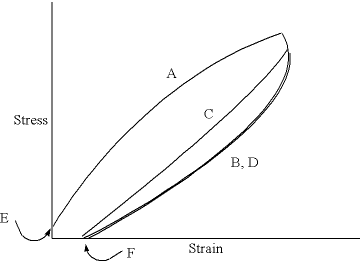

The elastic layer 110 is preferably stretched in the cross direction. More particularly, the elastic layer 110 is preferably stretched in the cross direction with one or more canted wheels. A tenter frame, intermeshing gears, or pin pads, for example, may also cross-directionally stretch the elastic layer 110.

As described above, one aspect of the presently described technology and one or more embodiments thereof may include one or more canted wheels. More particularly, the canted wheels preferably include one or more canted wheel pulleys. Each canted wheel pulley preferably includes a groove for a belt or other supportive device. The belt preferably includes a rubber belt, such as the rubber belts available from FAMECCANICA (Chieti, Italy). The canted wheels may also be referred to as diverging disks.

Alternatively, the elastic layer 110 may be stretched in the machine direction. More particularly, the elastic layer may be stretched in the machine direction, for example, with two or more pairs of rollers, each pair of rollers operating at different speeds, or intermeshing gears.

The elastic layer 110 may also be bi-axially or bi-directionally stretched (i.e., stretched in both the cross and machine directions). One of ordinary skill in the art will appreciate that the presently described technology and embodiments thereof may utilize a variety of stretching methods and resultant stretching directions, such as those described above.

The elastic layer 110 is preferably stretched or elongated from about 50 percent to about 300 percent of its pre-stretched dimensions. More preferably, the elastic layer 110 is stretched or elongated from about 80 percent to about 200 percent of its pre-stretched dimensions. Still more preferably, the elastic layer 110 is preferably stretched or elongated from about 100 percent to about 150 percent of its pre-stretched dimensions.

The non-woven layers 120, 130 are preferably stretched in the cross direction. More particularly, the non-woven layers 120, 130 are preferably stretched in the cross direction with pin pads. Alternatively, the non-woven layers 120, 130 may be cross-directionally stretched by canted wheels, a tenter frame, or intermeshing gears, for example.

Alternatively, the non-woven layers 120, 130 may be stretched in the machine direction. More particularly, the non-woven layers 120, 130 may be stretched in the machine direction with two or more pairs of rollers, each pair of rollers operating at different speeds, for example.

The non-woven layers 120, 130 may also be bi-axially or bi-directionally stretched (i.e., stretched in both the cross and machine directions) using a variety of stretching methods and resultant stretching directions, such as those described above.

The non-woven layers, such as the non-woven layers 120, 130 of FIG. 1, are preferably stretched or elongated up to about 75 percent of the elongation-to-break limit of the non-woven layers, in particular, the selected non-woven fabric(s) included in the non-woven layers.

The elastic laminate 100 may be stretched in the cross direction, machine direction, or both directions (i.e., bi-axially or bi-directionally). Further, one or more of the stretching systems described above, or any stretching system known to and appreciated by one of skill in the art, may stretch the elastic laminate 100. For example, one or more canted wheels may stretch the elastic laminate 100.

The stretched elastic layer 100 may be included as a component of an elastic article, such as a disposable infant diaper. For example, the elastic waistband in a disposable pull-up training diaper may include the stretched elastic laminate 100.

The elastic layer 110 is preferably attached or bonded to the non-woven layers 120, 130 by ultrasonic bonding. More particularly, the elastic layer 110 is preferably ultrasonically bonded or welded to the non-woven layers 120, 130 with a nonoverlapping dot bond pattern that collapses in the cross direction without interference between the dots. Additionally, adhesives are preferably utilized to bond or tack the edges of the elastic layer 110 and the non-woven layers 120, 130 together until ultrasonic bonding. Alternatively, the elastic layer 110 may be attached or bonded to the non-woven layers 120, 130 with one or more of the following attachment methods or bonding techniques: ultrasonic bonding; adhesive bonding; thermal bonding; chemical bonding (e.g., a naturally sticky elastic film); and mechanical interlocking.

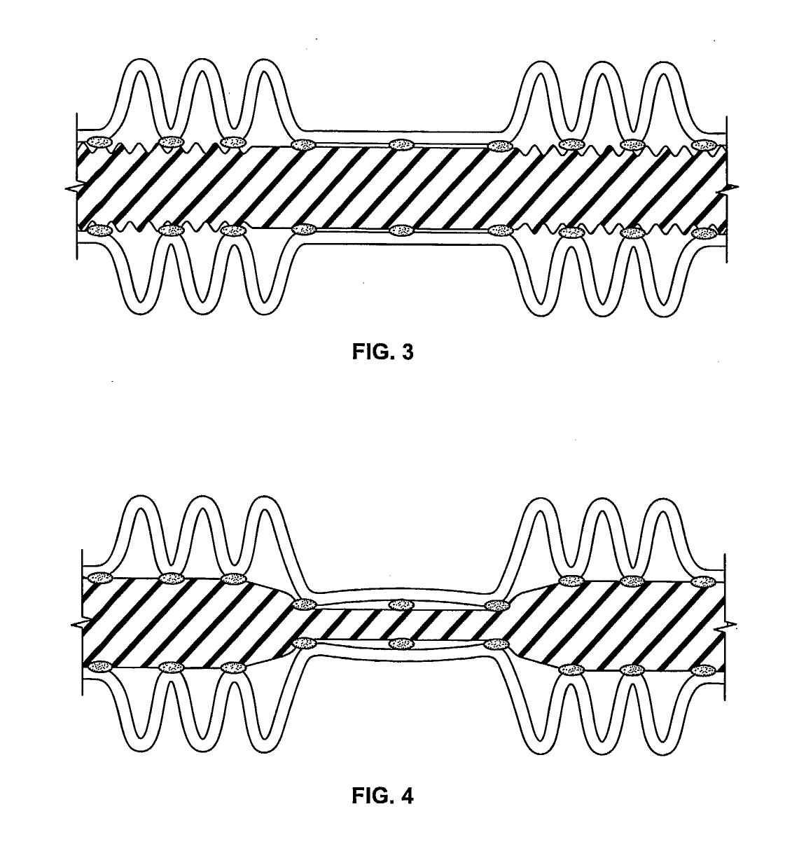

FIG. 2 illustrates a method 200 of manufacturing the elastic laminate 100 of FIG. 1, according to at least one embodiment of the presently described technology. The method 200 includes providing an elastic layer 210; providing non-woven layers 220; stretching the elastic layer 230; stretching the non-woven layers 240; creating inelastic regions in the elastic layer 250; attaching the stretched elastic layer to the stretched non-woven layer 260; releasing the stretch in the elastic layer to produce an elastic laminate 270; stretching and releasing the elastic laminate 280; applying heat to further shrink the elastic laminate 290; and winding the elastic laminate onto a roll 295.

At step 210, an elastic layer, such as the elastic layer 110 of FIG. 1, may be provided. The elastic layer may be pre-manufactured or pre-assembled. For example, the elastic layer may be introduced into a manufacturing line or system as a roll of elastic film. Alternatively, the elastic layer may be manufactured or assembled in time (i.e., simultaneously or contemporaneously) with the elastic laminate. For example, an elastic film may be manufactured with a small extruder and die on the same line or system for manufacturing the elastic laminate.

At step 220, non-woven layers, such as the non-woven layers 120, 130 of FIG. 1, may be provided. As with the elastic layer, the non-woven layers may be pre-manufactured or pre-assembled, or alternatively, manufactured or assembled in time.

At step 230, the elastic layer, such as the elastic layer 110 of FIG. 1, may be stretched. As previously described, the elastic layer is preferably stretched, for example, in the cross direction by a pair of canted wheels. Alternatively, for example, the elastic layer may be continuously stretched in the cross direction by a tenter frame or incrementally stretched in the cross direction by intermeshing gears. The elastic layer may be stretched in the machine direction, for example, with a pair of rollers, each pair of rollers operating at different speeds or intermeshing gears. The elastic layer may also be bi-axially or bi-directionally stretched (i.e., stretched in both the cross and machine directions) by the aforementioned methods and techniques. Furthermore, step 230 of method 200 can be performed or accomplished by any other stretching methods or techniques known to one of skill in the art.

The elastic layer is preferably stretched or elongated from about 50 percent to about 300 percent of its pre-stretched dimensions. More preferably, the elastic layer 110 is stretched or elongated from about 80 percent to about 200 percent of its pre-stretched dimensions. Still more preferably, the elastic layer 110 is preferably stretched or elongated from about 100 percent to about 150 percent of its pre-stretched dimensions.

At step 240, non-woven layers, such as non-woven layers 120, 130 of FIG. 1, may be stretched. As previously described, the non-woven layers are preferably stretched, for example, in the cross direction by pin pads. Alternatively, for example, the non-woven layers may be continuously stretched in the cross direction by a pair of canted wheels or a tenter frame or incrementally stretched in the cross direction by intermeshing gears. The non-woven layers may be stretched in the machine direction, for example, with a pair of rollers, each pair of rollers operating at different speeds. The non-woven layers may also be bi-axially or bi-directionally stretched (i.e., stretched in both the cross and machine directions) by the aforementioned methods or techniques. Furthermore, step 240 of method 200 may be performed or accomplished by any other stretching methods or techniques known to one of skill in the art.

The non-woven layers, such as the non-woven layers 120, 130 of FIG. 1, are preferably stretched or elongated up to about 75 percent of the elongation-to-break limit of the non-woven layers, in particular, the selected non-woven fabric(s) included in the non-woven layers.

As previously described, pre-stretching the non-woven layers may have several advantages. Stretching the non-woven layers is believed to reduce the amount of non-woven material required, and thus, the overall cost to produce the resultant elastic laminate, such as the elastic laminate 100 of FIG. 1. Additionally, it is believed that stretching the non-woven layers partially orients the fibers of the selected non-woven fabric(s), thereby creating a force wall indicator capable of warning the user that the elastic laminate may be becoming overstretched and on the verge of failure.

At step 250, inelastic regions (i.e., stiffened or deadened lanes or zones) may be created or formed in an elastic layer, such as the elastic layer 110 of FIG. 1. For example, the portion of the elastic layer in contact with and outside of the belts of the canted wheels may not stretch. Consequently, when the elastic layer is released, as described below, the non-woven layers, such as the non-woven layers 120, 130 of FIG. 1, corresponding to the portions of the elastic layer in contact with the belts of the canted wheels may not wrinkle, bunch, gather, or shirr like the rest of the non-woven layers.

If the inelastic regions are undesirable for any reason, particularly because such regions may be located or positioned on the edges as opposed to in the middle of the elastic layer, the stiffened or deadened lanes or zones may be trimmed or removed, for example, in a secondary removal or trimming operation.

If locating or positioning the inelastic regions in the middle of the elastic layer is desirable, one or more uncanted wheels can be used to hold or support selected portions of the elastic layer. More particularly, the canted wheels may not stretch the selected portions of the elastic layer in contact with the belts on the uncanted wheels. Additionally, the canted wheels may not stretch the selected portions of the elastic layer between two or more uncanted wheels, or alternatively, between a canted wheel and an uncanted wheel. Consequently, when the elastic layer is released, as described below, the non-woven layers corresponding to the selected portions of the elastic layer in contact with one or more, or between two or more uncanted wheels may not wrinkle, bunch, gather, or shirr like the rest of the non-woven layers.

Alternatively, the inelastic regions in the elastic layer may be created or formed by cross-directionally stretching and releasing regions of the elastic layer with intermeshing gears (IMG) prior to cross-directionally stretching the entire elastic layer, as described above at step 230. The IMG stretched or activated regions of the elastic layer may stretch more than the non-IMG stretched or inactivated regions of the elastic layer, or conversely, the inactivated regions may stretch less than the activated regions, if at all, as further illustrated in Table 3 below. Therefore, when the entire elastic layer is released, as described below at step 270, the non-woven layers attached to the inactivated or non-IMG stretched regions of the elastic layer may wrinkle, bunch, gather, or shirr, but only slightly, if at all, thereby producing corresponding inelastic regions in the elastic laminate. FIG. 3 illustrates a cross-sectional view of an elastic laminate with an inelastic region formed by incrementally stretching a portion of an elastic layer, according to at least one embodiment of the presently described technology.

Table 3, as provided below, illustrates the concept of preferential IMG stretching. More particularly, Table 3 illustrates an expected stress-strain curve A for the activated or IMG stretched regions of the elastic layer. Additionally, Table 3 illustrates an expected stress-strain curve B for the inactivated or non-IMG stretched regions of the elastic layer. For a given force or load, the activated regions (curve A) stretch or elongate more than the inactivated regions (curve B), or conversely, the inactivated regions may stretch less than the activated regions, if at all.

TABLE 3
Stress-Strain Curves for Activated (IMG Stretched) and
Inactivated Elastic Layers

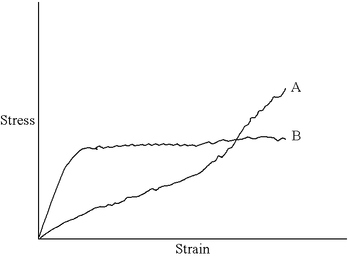

The inelastic regions in the elastic layer may also be formed by applying heat to relax selected portions of the stretched elastic layer. Heat is preferably applied to the stretched elastic layer after the stretched elastic layer is attached to the non-woven layers, as described below at step 260. Selected portions of the elastic layer may be heated and relaxed, for example, with a heated roller. Additionally, for example, a cooled roller at or below room temperature or an insulated ceramic plate may be utilized in the practice of the presently described technology to reduce, minimize, or prevent heat transfer from the heated roller into undesired areas of the stretched elastic layer. Consequently, when the elastic layer is released, as described below, the non-woven layers corresponding to the selected portions of the elastic layer that were heated and relaxed may not wrinkle, bunch, gather, or shirr like the rest of the non-woven layers.

Alternatively, for example, selected portions of the elastic layer may be heated and relaxed with infrared energy or radiation. More particularly, the selected portions of the elastic layer may be heated with an infrared heater, such as a Series CB or a Series FS infrared heater from DRI Infrared Drying and Heating Equipment (Tampa, Fla.). An insulated plate, such as an aluminum plate, may be used to mask or shield the rest of the elastic layer (i.e., reduce, minimize, or prevent heat transfer from the infrared heater to undesired areas of the elastic layer). Additionally, the mask or shield plate may be cooled with water, for example, to further reduce or minimize such heat transfer to the rest of the elastic layer. The insulated plate may also include openings or cut-outs, such as slots or holes, corresponding to the selected portions of the elastic layer in which heat is desired. Thus, the selected portions of the elastic layer may be heated and relaxed, while the remaining portions of the elastic layer remain stretched.

Selected portions of the elastic layer may be heated and relaxed with adhesives, such as those described below. Applying adhesive to the elastic layer may generate heat. The type and thickness of adhesive may be varied to regulate or control the amount of heat generated. For example, a layer of adhesive of sufficient type and thickness may be applied to selected portions of the elastic layer to heat and relax those portions of the elastic layer, thereby producing or creating inelastic regions in the elastic layer when attached to the non-woven layers and released to form a resultant elastic laminate, as described below.

In an embodiment of the presently described technology, if the elastic laminate includes a heat shrink elastic layer, then heat may be selectively withheld from at least a portion of the heat shrink elastic layer to form one or more inelastic regions in the elastic laminate. In other words, the unheated portion(s) of the heat shrink elastic layer may not shrink or contract, thereby creating one or more inelastic regions in the elastic laminate.

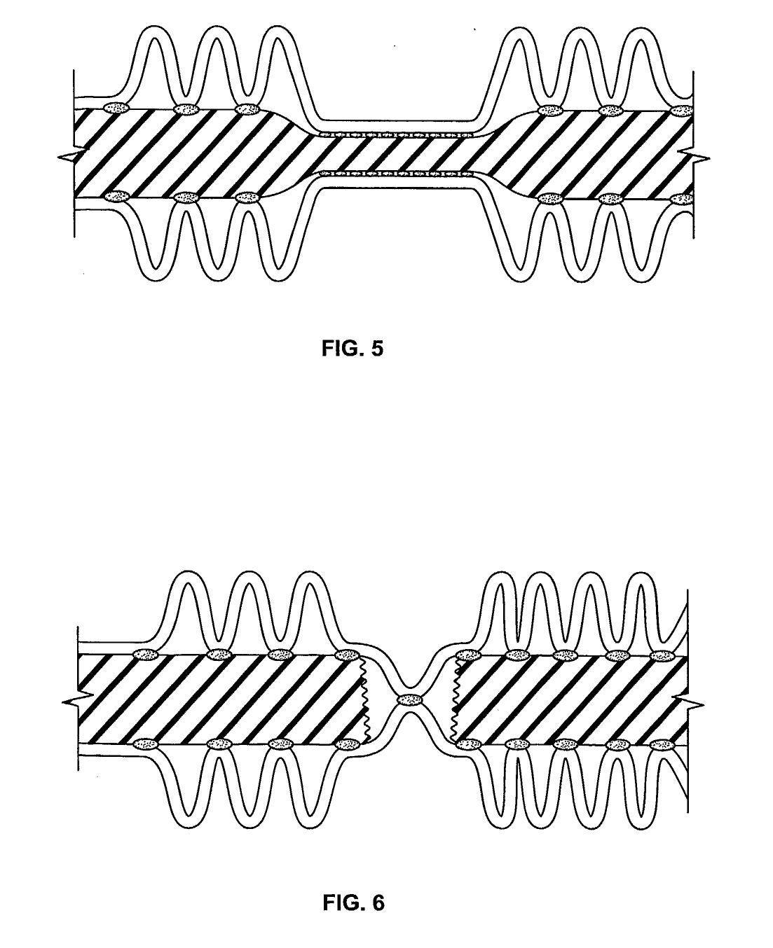

FIG. 4 illustrates a cross-sectional view of an elastic laminate with an inelastic region formed by selectively applying heat to a portion of an elastic layer, according to at least one embodiment of the presently described technology.

The inelastic regions in the elastic layer may also be created or produced by ultrasonic bonding in selected areas of the stretched elastic layer. If the distance or spacing between ultrasonic bond points is large (greater than about 8 mm, for example), then the selected portions of the stretched elastic layer may contract or relax when released. Conversely, if the distance or spacing between ultrasonic bond points is small (less than about 1 mm, for example), then the selected portions of the stretched elastic layer may not contract or relax when released. Consequently, the non-woven layers corresponding to the selected portions of the elastic layer that were rigidly bonded in a heavy or tight ultrasonic bond pattern (i.e., small distance or spacing between ultrasonic bond points) may not wrinkle, bunch, gather, or shin like the rest of the non-woven layers. FIG. 5 illustrates a cross-sectional view of an elastic laminate with an inelastic region formed by ultrasonic bonding a portion of an elastic layer, according to at least one embodiment of the presently described technology.

Alternatively, the stiffened or deadened lanes or zones in the elastic layer may be created or produced by cutting, severing, or zippering the elastic layer. More particularly, the elastic layer may be attached or bonded to the non-woven layers, as described herein, along the machine-direction boundary or boundaries corresponding to the inelastic regions. Subsequently, the elastic layer may be cut or severed inside of the machine-direction boundary or boundaries corresponding to the inelastic regions. For example, the elastic layer may be cut or severed ultrasonically, with an ultrasonic bonding machine or an ultrasonic welder. Alternatively, the elastic layer may be cut, severed, or zippered mechanically, with a pinned wheel or roller, whereby the pins poke through the non-woven layers and cut, sever, or zipper the elastic layer. When cut, severed, or zippered, the elastic layer may return to a relaxed or unstretched state or condition. Thus, when the stretched elastic layer is released, as described below, the non-woven layers corresponding to the unstretched portions of the elastic layer that were cut, severed, or zippered may not wrinkle, bunch, gather, or shirr like the rest of the non-woven layers. FIG. 6 illustrates a cross-sectional view of an elastic laminate with an inelastic region formed by severing a portion of an elastic layer, according to at least one embodiment of the presently described technology.

The inelastic regions, or stiffened or deadened lanes or zones, in the elastic layer may be desirable for improved attachment to other members of elastic articles, such as a disposable infant diaper.

At step 260, the stretched elastic layer, such as the stretched elastic layer 110 of FIG. 1, can be attached to the stretched non-woven layers, such as the stretched non-woven layers 120, 130 of FIG. 1. As previously described, the elastic layer is preferably attached or bonded to the non-woven layers by ultrasonic bonding or welding. More particularly, one of the non-woven layers may be ultrasonically bonded to another of the non-woven layers through the elastic layer, thereby attaching the elastic layer to the non-woven layers. The elastic layer is preferably ultrasonically bonded to the non-woven layers with a non-overlapping dot bond pattern that collapses in the cross direction without interference between the dots. A sufficient force, amplitude, and frequency may be provided by the ultrasonic bonding system to melt some of the non-woven layers at most of the bond sites. As appreciated by one of skill in the art, the force, amplitude, and/or frequency may be varied to achieve the desired level of bonding.

Adhesives are preferably utilized to bond or tack the elastic layer to the non-woven layers prior to ultrasonic bonding. For example, elastic film may be bonded or tacked to non-woven fabric with a construction or chassis adhesive, such as 34901B adhesive available from National Starch and Chemical Company (Bridgewater, N.J.).

Alternatively, the elastic layer may be attached or bonded to the non-woven layers with one or more of the following attachment methods or bonding techniques: ultrasonic welding; adhesive bonding; thermal bonding; chemical bonding (e.g., a naturally sticky elastic film); and mechanical interlocking.

At step 270, the stretch in the elastic layer, such as the elastic layer 110 of FIG. 1, may be released to produce or form an elastic laminate, such as the elastic laminate 100 of FIG. 1. More particularly, the stretch of the elastic layer may be released when the elastic layer is no longer in contact with the stretching system, or the holding or gripping system, such as the canted wheels, tenter frame, or intermeshing gears. The elastic layer 110, which is generally elastic, can return to approximately its pre-stretched dimensions. The elastic layer preferably returns to within about 30 percent of its pre-stretched dimensions when released. More preferably, the elastic layer returns to within about 20 percent of its pre-stretched dimensions when released. Still more preferably, the elastic layer returns to within about 10 percent of its pre-stretched dimensions when released.

Conversely, the non-woven layers, such as the non-woven layers 120, 130 of FIG. 1, which are generally inelastic (i.e., permanently stretched, elongated, or deformed), may remain operatively attached or bonded to the elastic layer, and may proceed to wrinkle, bunch, gather, or shirr as the elastic layer returns to approximately its pre-stretched dimensions.

At step 280, the elastic laminate, such as the elastic laminate 100 of FIG. 1, may be stretched and released. One or more of the stretching systems described above, or any stretching system known to and appreciated by one of skill in the art, may stretch the elastic laminate. For example, a pair of canted wheels may stretch the elastic laminate. The elastic laminate is preferably stretched or elongated from about 80 percent to about 120 percent of the stretch or elongation of the elastic layer, such as the elastic layer 110 of FIG. 1. For example, if the elastic layer is stretched or elongated to 100 percent of its pre-stretched, pre-activated dimensions, then the elastic laminate may be stretched or elongated from about 80 percent to about 120 percent of its pre-stretched dimensions. As appreciated by one of ordinary skill in the art, the elastic laminate should not be stretched beyond the limit of the underlying elastic layer, even if the limit is within the aforementioned range.

As previously discussed, stretching the elastic laminate for the first time may have several advantages. The elastic laminate may be easier to stretch the second and subsequent times as compared to the first or initial time. Additionally, the elastic laminate may stretch more consistently between second and subsequent stretches as compared to the first or initial stretch.

At step 290, heat may be applied to the elastic laminate, such as the elastic laminate, such as the elastic laminate 100 of FIG. 1, to further shrink the elastic layer, such as the heat shrink elastic layer 100 of FIG. 1. Heat may be applied by one or more of the heating systems described herein, or any heating system known to and appreciated by one of ordinary skill in the art. This step is optional and may apply if, for example, the elastic layer includes a heat shrink material.

Heat shrink materials preferably include, but are not limited to ethylene copolymers, such as EVA, EMA, or EAA. Additionally, heat shrink materials may also include very low density materials, such as metallocene catalyzed LLDPE. Heat shrink materials are preferably activated at temperatures ranging from about 120 degrees Fahrenheit to about 200 degrees Fahrenheit. More preferably, heat shrink materials are preferably activated at temperatures ranging from about 120 degrees Fahrenheit to about 140 degrees Fahrenheit. The application of heat preferably contracts the heat shrink elastic layer 110 by at least about 20 percent of its inactivated dimensions, more preferably about 35 percent of its inactivated dimensions, and still more preferably about 50 percent of its inactivated dimensions.

As previously described, heat shrink materials can be limited by activation temperature. More particularly, other materials in or components of the elastic laminate must be compatible with the activation temperature if a heat shrink material is to be used in the elastic laminate. However, in at least one embodiment of the presently described technology, such compatibility issues may be easily regulated or controlled since the elastic laminate is fully constructed in a single operation.

Additionally, heat shrink materials are typically more affordable than more elastic materials. Since most of the elastic properties of the elastic laminate stem or derive from stretching the elastic layer rather than contraction of a heat shrink material, more affordable elastic materials (i.e., elastic materials with less elasticity) may be used in combination with heat shrink materials to produce an elastic laminate with the desired level of elasticity.

At step 295, the elastic laminate, such as the elastic laminate 100 of FIG. 1, may be wound onto a roll or in a rolled configuration. The bulk of the elastic laminate may be problematic, especially in carrying out this step. However, the elastic laminate may be compressed during the winding operation 295. Alternatively, imparting a fine bond pattern onto the non-woven layers, such as the non-woven layers 120, 130 of FIG. 1, to create frequent small loops in the non-woven layers may also mitigate some of the bulk.

As will be appreciated by those of skill in the art, certain steps of the described method(s) may be performed in ways other than those recited above and the steps may be performed in sequences other than those recited above. Additionally, certain steps may be omitted, for example, step 250 if inelastic regions are not desired or step 290 if heat shrink materials are not used.

The following additional methods are also contemplated.

Step 230 may be eliminated resulting in a stretched non-woven layer being attached to a non-stretched elastic layer.

Step 240 may be eliminated resulting in a non-stretched non-woven layer being attached to a stretched elastic layer, with or without heat shrink materials.

Steps 230 and 240 may be selectively eliminated such that step 280 may be performed on any elastic laminate resulting from any combination of stretched or non-stretched elastic layers and non-woven layers.

Steps 230 and 240 may be selectively eliminated such that step 250 may be performed on any combination of stretched or non-stretched elastic layers and non-woven layers. This method further contemplates eliminating step 280.

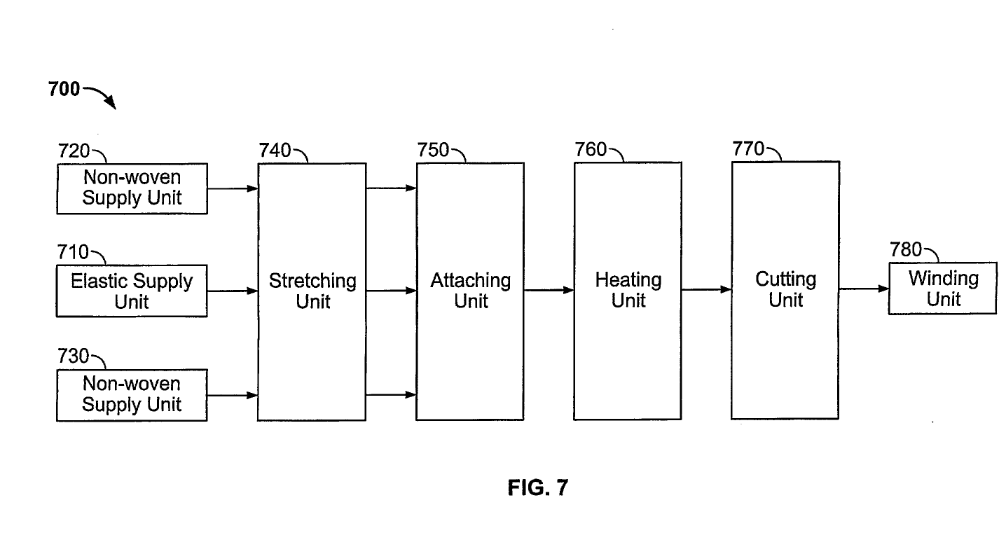

FIG. 7 illustrates a system 700 for manufacturing an elastic laminate, such as the elastic laminate 100 of FIG. 1, according to at least one embodiment of the presently described technology. The system 700 includes the following subsystems: at least one elastic supply unit 710, at least two non-woven supply units 720, 730, a stretching unit 740, an attaching unit 750, a heating unit 760, a cutting unit 770, and a winding unit 780. Alternatively, the system 700 may include only one non-woven supply unit. As appreciated by one of skill in the art, the system may include multiple elastic and non-woven supply units 710, 720, as dictated by the number of elastic and non-woven layers included in the elastic laminate.

The elastic supply unit 710 of the system 700 may provide or supply an elastic layer, such as the elastic layer 110 of FIG. 1. For example, the elastic supply unit 710 may include a roll of elastic material.

The non-woven supply units 720, 730 of the system 700 may provide or supply non-woven layers, such as the non-woven layers 120, 130 of FIG. 1. For example, the non-woven supply units 720, 730 may include rolls of non-woven material.

The stretching unit 740 of the system 700 may stretch an elastic layer, such as the elastic layer 110 of FIG. 1, non-woven layers, such as the non-woven layers 120, 130 of FIG. 1, and/or an elastic laminate, such as the elastic laminate 100 of FIG. 1. For example, the one or more stretching units 740 may include a pair of canted wheels, a tenter frame, or intermeshing gears or combination of these stretching devices, as described above. In one embodiment of the presently described technology, the stretching unit 740 of the system 700 may stretch a portion of an elastic layer to form an inelastic region, such as the inelastic region of FIG. 3.

The attaching unit 750 of the system 700 may attach an elastic layer, such as the elastic layer 110 of FIG. 1, to non-woven layers, such as the non-woven layers 120, 130 of FIG. 1. For example, the attaching unit 750 may include an ultrasonic welder or an adhesive applicator, as described above. In one embodiment of the presently described technology, the attaching unit 750 may attach a portion of the elastic layer to the non-woven layers to form an inelastic region, such as the inelastic region of FIG. 5. In another embodiment of the presently described technology, the attaching unit 750 may attach the non-woven layers to each other through the elastic layer.

The heating unit 760 of the system 700 may apply heat to an elastic layer, such as the elastic layer 100 of FIG. 1. For example, the heating unit 760 may include heated rollers, an infrared oven, or an adhesive applicator, as described above. In one embodiment of the presently described technology, the heating unit 760 may apply heat to the elastic layer to activate a heat shrink material and/or to a portion of the elastic layer to form an inelastic region, such as the inelastic region of FIG. 4.

The cutting unit 770 of the system 700 may sever or cut an elastic layer, such as the elastic layer 110 of FIG. 1, non-woven layers, such as the non-woven layers 120, 130 of FIG. 1, and/or an elastic laminate, such as the elastic laminate 100 of FIG. 1. For example, the cutting unit 770 may include an ultrasonic cutter or a wheel with pins, as described above. In one embodiment of the presently described technology, the cutting unit 770 may sever or cut a portion of the elastic layer to form an inelastic region, such as the inelastic region of FIG. 6.

The winding unit 780 of the system 700 may wind the elastic laminate, such as the elastic laminate 100 of FIG. 1, onto a roll, for example. For example, the winding unit 780 may include a winder for compressing and/or patterning the elastic laminate to mitigate some of the bulk, as described above.

In operation, the elastic supply unit 710 supplies at least one elastic layer. The non-woven supply units 720, 730 supply at least two non-woven layers. The stretching unit 740 stretches the elastic and non-woven layers. The attaching unit 750 attaches the stretched elastic layer to the stretched non-woven layers, or alternatively, the stretched non-woven layers to each other through the stretched elastic layer, to form an elastic laminate. The stretching layer 750 also stretches the elastic laminate. The cutting unit 770 cuts the elastic laminate into a predetermined length and/or shape. The winding unit 780 winds the cut elastic laminate onto a roll.

In one embodiment of the presently described technology, the stretching unit 740, attaching unit 750, heating unit 760, and cutting unit 770 may be implemented to form inelastic regions (i.e., stiffened or deadened lanes or zones), as described above.

In another embodiment of the presently described technology, the heating unit 760 may be utilized to activate a heat shrink material in the previously stretched elastic layer, as described above.

As will be appreciated by one of skill in the art, each of the subsystems 710-780 of the system 700 may include multiple units or devices, although only one unit or device is referenced and described above. For example, the system 700 may include multiple stretching units 740, one stretching unit for stretching the elastic layer, a second stretching unit for stretching the non-woven layers, a third stretching unit for stretching the elastic laminate, and a fourth stretching unit for stretching a portion of the elastic layer to form an inelastic region. Furthermore, multiple supply, heating, attaching, cutting, and/or winding units may be implemented as needed.

The presently described technology and the manner and process of making and using it, are now described in such full, clear, concise and exact terms as to enable one of ordinary skill in the art to which the present technology pertains, to make and use the same. It should be understood that the foregoing describes some embodiments and advantages of the invention and that modifications may be made therein without departing from the spirit and scope of the presently described technology as set forth in the claims. Moreover, the invention has been described with reference to preferred and alternate embodiments. Modifications and alterations will occur to others upon the reading and understanding of the specification. It is intended to include all such modifications and alterations insofar as they come within the scope of the appended claims or equivalents thereof. To particularly point out and distinctly claims the subject matter regarded as the invention, the following claims conclude this specification.

1. An elastic laminate with a cross-direction stretched non-woven layer, the elastic laminate comprising:
an elastic layer; and
a non-woven layer,
wherein the non-woven layer is cross-directionally stretched and subsequently attached to the elastic layer.

2. (canceled)

3. The elastic laminate of claim 1, wherein the non-woven layer is stretched in the cross direction with at least one canted wheel.

4. The elastic laminate of claim 1, wherein the non-woven layer is stretched in the cross direction with at least one pin pad.

5. The elastic laminate of claim 1, wherein the stretched non-woven layer is attached to the elastic layer by at least one adhesive.

6. The elastic laminate of claim 1, wherein the stretched non-woven layer is attached to the elastic layer by ultrasonic welding.

7. The elastic laminate of claim 1, wherein the elastic layer is continuously stretched and subsequently attached to the stretched non-woven layer.

8. The elastic laminate of claim 1, wherein the elastic layer is incrementally stretched and subsequently attached to the non-woven layer.

9. The elastic laminate of claim 1, wherein the non-woven layer is patterned.

10. The elastic laminate of claim 9, wherein the pattern is a fine bond pattern.

11. A method for manufacturing an elastic laminate with a cross-direction stretched non-woven layer, the elastic laminate comprising:
stretching a non-woven layer in a cross-direction; and
attaching an elastic layer to the cross-direction stretched non-woven layer.

12. The method of claim 11, further comprising stretching the elastic laminate.

13. The method of claim 11, wherein the elastic layer is contracted at least about 20 percent by the application of heat.

14. The method of claim 11, wherein the non-woven layer is stretched up to about 75 percent of the elongation-to-break limit of the non-woven layer.

15.-62. (canceled)

63. An elastic laminate comprising:
an elastic layer; and
a non-woven layer,
wherein the elastic layer is stretched and subsequently attached to the non-woven layer.

64. The elastic laminate of claim 63, wherein the elastic layer is a heat shrink layer.

65. The elastic laminate of claim 64, wherein the heat shrink elastic layer includes a heat shrink skin layer.

66. The elastic laminate of claim 64, wherein the heat shrink elastic layer includes a heat shrink core layer.

67. The elastic laminate of claim 64, wherein the heat shrink elastic layer comprises a material selected from the group consisting of ethylene copolymer, ethylene-vinyl acetate, ethylene methacrylate, ethylene acrylic acid, and metallocene catalyzed linear low density polyethylene.

68. The elastic laminate of claim 63, wherein the elastic laminate is stretched after the stretched elastic layer is attached to the non-woven layer.

69. The elastic laminate of claim 63, wherein a portion of the stretched elastic layer is heated to form an inelastic region.

70. The elastic laminate of claim 63, wherein a portion of the elastic layer is stretched and then the entire elastic layer is stretched to form an inelastic region, and the stretched elastic layer is then attached to the non-woven layer.

71. The elastic laminate of claim 63, wherein a portion of the stretched elastic layer is rigidly attached to the non-woven layer to form an inelastic region.

72. The elastic laminate of claim 71, wherein the portion of the elastic layer is rigidly attached to the non-woven layer with ultrasonic bonding.

73. The elastic laminate of claim 71, wherein the portion of the elastic layer is rigidly attached to the non-woven with adhesive.

74. A method for manufacturing a heat shrink elastic laminate comprising the steps of:
stretching a heat shrink elastic layer;
attaching the stretched heat shrink elastic layer to a non-woven layer; and
applying heat to activate and thereby contract the heat shrink layer.

75. The method of claim 74, wherein the heat shrink layer is activated at a temperature ranging from about 120 degrees Fahrenheit to about 200 degrees Fahrenheit.

76. The method of claim 74, wherein the heat shrink layer is activated at a temperature ranging from about 120 degrees Fahrenheit to about 140 degrees Fahrenheit.

77. A method for manufacturing a stretched elastic laminate, the method comprising:
stretching an elastic layer;
attaching the stretched elastic layer to a non-woven layer to form an elastic laminate; and
stretching the elastic laminate.

78. The method of claim 77, wherein the elastic laminate is stretched in a cross direction.

79. The method of claim 78, wherein the elastic laminate is stretched in the cross direction by at least one canted wheel.

80. The elastic laminate of claim 78, wherein the elastic laminate is stretched in the cross direction by at least one pin pad.

81. The method of claim 77, wherein the elastic laminate is continuously stretched.

82. The method of claim 77, wherein the elastic layer is stretched about 50 percent to about 300 percent.

83. The method of claim 77, wherein the elastic layer is stretched about 80 percent to about 200 percent.

84. The method of claim 77, wherein the elastic layer is stretched about 100 percent to about 150 percent.

85. The method of claim 77, wherein the elastic laminate is stretched about 80 percent to about 120 percent of the stretch of the elastic layer.

86. The method of claim 77, further including attaching the stretched elastic laminate to an article.

87. A method for manufacturing an elastic laminate with an inelastic region, the method comprising:
stretching an elastic layer;
attaching the stretched elastic layer to a non-woven layer; and
forming an inelastic region in at least a portion of the stretched elastic layer.

88. The method of claim 87, wherein the inelastic region is formed by heating a portion of the stretched elastic layer.

89. The method of claim 88, wherein the portion of the elastic layer is heated with a hot roller.

90. The method of claim 88, wherein the portion of the elastic layer is heated with an infrared heater.

91. The method of claim 88, wherein the portion of the elastic layer is heated with adhesive.

92. The method of claim 87, wherein the inelastic region is formed by stretching a portion of the elastic layer and then stretching the entire elastic layer.

93. The method of claim 92, wherein the portion of the elastic layer is stretched with intermeshing gears.

94. The method of claim 92, wherein the entire elastic layer is stretched with at least one canted wheel.

95. An elastic laminate with an inelastic region, the elastic laminate comprising:
an elastic layer; and
a non-woven layer,
wherein a first portion of the elastic layer is attached to the non-woven layer and a second portion of the elastic layer is severed from the first portion of the elastic layer to form an inelastic region.

96. The elastic laminate of claim 95, wherein the second portion of the elastic layer is severed from the first portion of the elastic layer with an ultrasonic welder.

97. The elastic laminate of claim 95, wherein the second portion of the elastic layer is severed from the first portion of the elastic layer with a wheel and pins.

98. A method for manufacturing an elastic laminate with an inelastic layer, the method comprising:
attaching a first portion of the elastic layer to a non-woven layer; and
severing a second portion of the elastic layer from the first portion of the non-woven layer to form an inelastic region.
